(19) United States
(12) Patent Application Publication
(10) Pub. No.: US 2026/0048628 A1
(43) Pub. Date: Feb. 19, 2026

(54) HOLDING DEVICE

(71) Applicant: ACPS Automotive GmbH, Ingersheim (DE)

(72) Inventor: Kun Yang, Leonberg (DE)

(73) Assignee: ACPS Automotive GmbH, Ingersheim (DE)

(21) Appl. No.: 19/289,641

(22) Filed: Aug. 4, 2025

(30) Foreign Application Priority Data
Aug. 15, 2024 (DE) 102024123333.8

(51) Int. Cl. B60D 1/54; B60D 1/06; B60D 1/48

(52) U.S. Cl. CPC B60D 1/54; B60D 1/06; B60D 1/485; B60D 2001/544

(57) ABSTRACT

In order to improve holding device that is mountable on a rear region of a body of a motor vehicle, comprising a pivotal bearing unit, which is mountable in a manner fixed to the vehicle on the rear region of the motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa, wherein by way of a connection arm the pivot element is provided with an attachment element carrier that has an insertion receptacle and in which the attachment element is insertable and fixable with positive engagement by an end region, wherein in the working position the insertion receptacle extends with its center axis substantially parallel to the longitudinal center plane, and wherein the attachment element carrier comprises a receiving body that has an insertion receptacle, the improvement being such that the connection arm is provided with a holding arm that is connected to the receiving body.

### CROSS-REFERENCE TO RELATED PATENT APPLICATION

The present disclosure relates to the subject matter disclosed in German application number 10 2024 123 333.8 of 15 Aug. 2024, which is incorporated herein by reference in its entirety and for all purposes.

### BACKGROUND OF THE INVENTION

The invention relates to a holding device that is mountable on a rear region of a body of a motor vehicle, comprising a pivotal bearing unit, which is mountable in a manner fixed to the vehicle on the rear region of the motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa, wherein by way of a connection arm the pivot element is provided with an attachment element carrier that has an insertion receptacle and in which the attachment element is insertable and fixable with positive engagement by an end region, wherein in the working position the insertion receptacle extends with its center axis substantially parallel to the longitudinal center plane, and wherein the attachment element carrier comprises a receiving body that has an insertion receptacle.

Holding devices of this type are known from the prior art. With these, the problem arises of providing a simple and effective connection between the connection arm and the receiving body.

### SUMMARY OF THE INVENTION

In accordance with an embodiment of the invention, provision is made in a holding device of the type mentioned in the introduction that the connection arm is provided with a holding arm that is connected to the receiving body.

The advantage of this solution can be seen in the fact that it provides a simple way of making a stable and sustained connection between the connection arm and the receiving body.

Fundamentally, the holding arm could extend in any direction relative to the receiving body.

A particularly advantageous solution provides for the holding arm to extend parallel to the center axis in the longitudinal direction of the receiving body.

This solution has the advantage that it makes a connection producible between the holding arm and the receiving body in a simple manner, and moreover, also as a result of this connection, the forces acting on the receiving body can be optimally transferred to the connection arm by way of the holding arm.

In particular here, it is provided for the holding arm to form a wall region of the receiving body that delimits the insertion receptacle.

That is to say that the holding arm is integrated into the receiving body and is itself part of the receiving body.

In this context, the holding arm could be integrated into different walls of the receiving body.

A particularly advantageous solution provides for the holding arm to form an, in the working position, upper transverse wall of the receiving body.

Furthermore, for the purpose of forming the receiving body, it is provided for it to comprise a supplementary body which is connected to the holding arm and forms the further side walls of the insertion receptacle.

In this context, the supplementary body may take any desired form. It is particularly favorable if the supplementary body takes a form that is U-shaped in cross section.

In this case, the advantageous solution consists in the fact that side cheeks of the supplementary body that adjoin the holding arm embrace the wall region formed by it on both sides.

Furthermore, it is advantageously provided for the side cheeks of the supplementary body to be connected to the side faces of the holding arm and thus to enable a stable connection between the holding arm and the supplementary body.

In particular here, it is provided for the supplementary body to be screwed to the holding arm.

As an alternative, however, it is also conceivable for the supplementary body to be welded to the holding arm.

A further alternative embodiment of the solution according to the invention provides for the holding arm to abut against a side of the receiving body.

That is to say that the receiving body is an enclosed body, and the holding arm abuts against only one side of the receiving body, in particular an outer side thereof.

It is preferable here if the holding arm is configured such that it abuts against at least one longitudinal side of the receiving body.

A particularly stable connection between the holding arm and the receiving body is producible if the holding arm has a holding portion taking the form of an upside-down U and abutting against the receiving body.

In this case, it is for example provided for the holding portion to be provided with lateral embracing elements which, laterally in relation to the longitudinal side of the receiving body that is covered by the holding portion, at least in certain regions abut against longitudinal sides that adjoin the longitudinal side.

Thus, support of the receiving body by the holding portion is possible not only in the region of the longitudinal side that is covered by the holding portion but also by abutment against the longitudinal sides that adjoin the covered longitudinal side, with the result that the receiving body is stabilized in three directions relative to the holding portion.

A particularly advantageous solution in this context provides for the holding portion to be welded to the receiving body.

In order to enable optimum positioning of the receiving body in the rest position, it is preferably provided for the insertion opening to extend with its center axis transverse to the longitudinal center plane in the rest position, wherein the center axis runs in particular such that it is inclined relative to a direction of a road surface.

Thus, the description above of solutions according to the invention comprises in particular the different combinations of features that are defined by the sequentially numbered embodiments below:

A holding device (20) that is mountable on a rear region (14) of a body (12) of a motor vehicle (10), comprising a pivotal bearing unit (30), which is mountable in a manner fixed to the vehicle on the rear region (14) of the motor vehicle (10), in particular a passenger car, by a carrier unit (22), and on which a pivot element (32) that carries an attachment element (50) is mounted to pivot about a pivot axis (36) running transversely, in particular obliquely, to a longitudinal center plane (34) and is thus pivotal from a working position (A) to a rest position (R) and vice versa, wherein by way of a connection arm (38) the pivot element (32) is provided with an attachment element carrier (40) that has an insertion receptacle (46) and in which the attachment element (50) is insertable and fixable with positive engagement by an end region (56), wherein in the working position (A) the insertion receptacle (46) extends with its center axis (44) substantially parallel to the longitudinal center plane (34), and wherein the attachment element carrier (40) comprises a receiving body (42, 112) that has the insertion receptacle (46), wherein the connection arm (38) is provided with a holding arm (60, 110) that is connected to the receiving body (42, 112).

The holding device according to embodiment 1, wherein the holding arm (60, 110) extends parallel to the center axis (44) in the longitudinal direction of the receiving body (42, 112).

The holding device according to embodiment 2, wherein the holding arm (60) forms a wall region (62) of the receiving body (42) that delimits the insertion receptacle (46).

The holding device according to embodiment 2 or 3, wherein the holding arm (60) forms an, in the working position (A), upper transverse wall (62) of the receiving body (42).

The holding device according to embodiment 3 or 4, wherein the receiving body (42) comprises a supplementary body (70) which is connected to the holding arm (60) and forms the further side walls (82, 84, 86) of the insertion receptacle (46).

The holding device according to one of embodiments 3 to 5, wherein the supplementary body (70) takes a form that is U-shaped in cross section.

The holding device according to one of embodiments 3 to 6, wherein side cheeks (72, 74) of the supplementary body (70) that adjoin the the holding arm (60) embrace the wall region (62) formed by it on both sides.

The holding device according to embodiment 7, wherein the side cheeks (72, 74) of the supplementary body (70) are connected to side faces of the holding arm (60).

The holding device according to one of embodiments 3 to 8, wherein the supplementary body (70) is screwed to the holding arm (60).

The holding device according to one of embodiments 1 or 2, wherein the holding arm (110) abuts against a side (122) of the receiving body (112).

The holding device according to embodiment 10, wherein the holding arm (110) abuts against at least one longitudinal side (122) of the receiving body (112).

The holding device according to embodiment 11, wherein the holding arm (110) has a holding portion (124) taking the form of an upside-down U and abutting against the receiving body (112).

The holding device according to embodiment 12, wherein the holding portion (124) is provided with lateral embracing elements (126, 128) which, laterally in relation to the longitudinal side (122) of the receiving body (112) that is covered by the holding portion (124), at least in certain regions abut against longitudinal sides (132, 134) that adjoin the longitudinal side.

The holding device according to embodiment 12 or 13, wherein the holding portion (124) is welded to the receiving body (112).

Further features and advantages of the solution according to the invention form the subject matter of the description below and of some exemplary embodiments represented in the drawing.

### BRIEF DESCRIPTION OF THE DRAWINGS

FIG. 1 shows a side view of a rear region of a motor vehicle with a holding device according to the invention;

FIG. 2 shows a perspective illustration of a first exemplary embodiment of the holding device according to the invention, in the working position;

FIG. 3 shows an illustration of the first exemplary embodiment of the holding device according to the invention, as seen in the direction of the arrow A in FIG. 2;

FIG. 4 shows an illustration of the first exemplary embodiment of the holding device according to the invention, corresponding to FIG. 3 but in the rest position;

FIG. 5 shows an illustration of the first exemplary embodiment, corresponding to FIG. 3;

FIG. 6 shows a side view of the first exemplary embodiment, in the direction of the arrow B in FIG. 5;

FIG. 7 shows a plan view of the first exemplary embodiment of the holding arm according to the invention, in the direction of the arrow C in FIG. 3;

FIG. 8 shows a perspective illustration of a second exemplary embodiment of the holding device according to the invention, similar to FIG. 2;

FIG. 9 shows an enlarged illustration of the attachment element carrier according to FIG. 8;

FIG. 10 shows a side view of the second exemplary embodiment, as seen in the direction of the arrow D in FIG. 8; and

FIG. 11 shows an illustration of the second exemplary embodiment, as seen in the direction of the arrow E in FIG. 8.

### DETAILED DESCRIPTION OF THE INVENTION

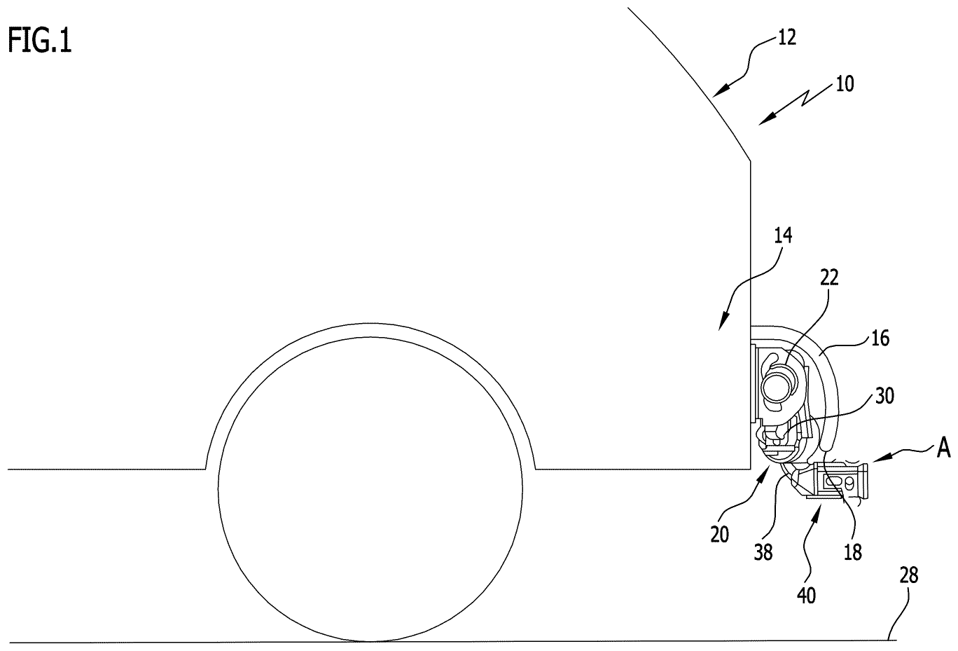

An exemplary embodiment, illustrated in FIG. 1, of a motor vehicle 10 according to the invention comprises a body 12 that carries a rear bumper unit 16 on a rear region 14.

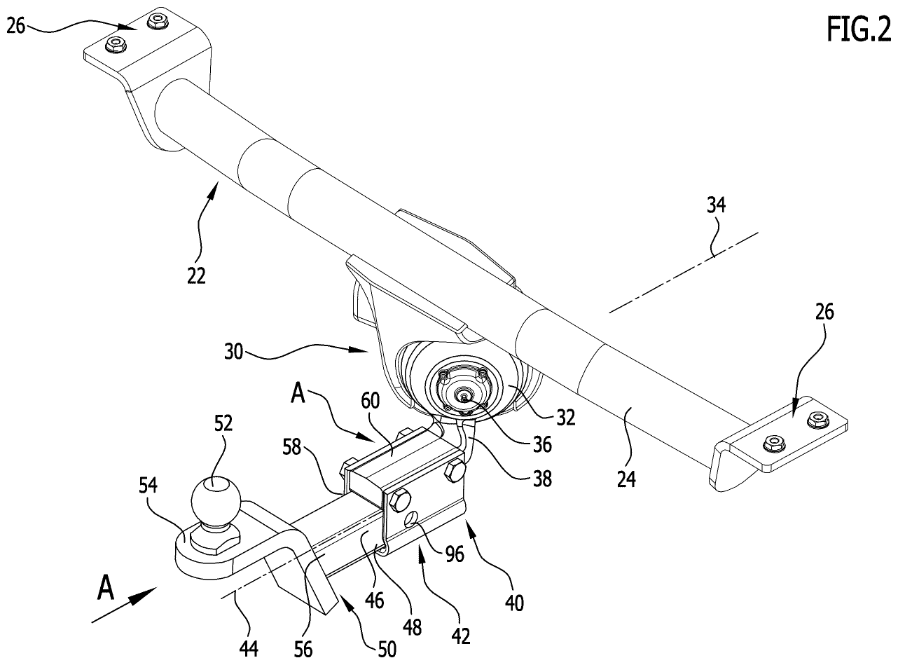

Further, arranged on the rear region is a first exemplary embodiment of a holding device, which is designated 20 as a whole, and which has a carrier unit 22 that is arranged below the bumper unit 16 such that it is hidden by it, wherein the carrier unit 22 comprises, as illustrated in FIG. 2, a transverse carrier 24 that is connected to the rear region 14 by lateral connection elements 26.

Further, held on the carrier unit 22, in particular in a central region of the transverse carrier 24, is a pivotal bearing unit, which is designated 30 as a whole and on which a pivot element 32 is mounted such that it is pivotal about a pivot axis 36 that extends transversely to a vehicle longitudinal center plane 34 of the body 12, which is at the same time also a longitudinal center plane 34 of the holding device 20 (FIGS. 2 to 4).

In a first exemplary embodiment, an attachment element carrier 40 extends from the pivot element 32 and comprises a connection arm 38 which extends from the pivot element 32 and to which is connected a receiving body, designated 42 as a whole, wherein the receiving body 42 forms an insertion receptacle 46 that extends therein along a center axis 44, wherein, as illustrated in FIG. 2, insertable in a receiving opening 48 of the insertion receptacle 46 that is opposed to the direction of forward travel is for example, as an attachment element 50, a coupling ball carrier 56 that carries at an end 54 a coupling ball 52 and is insertable in the receiving opening 48 by an opposite end region 58 to the end 54.

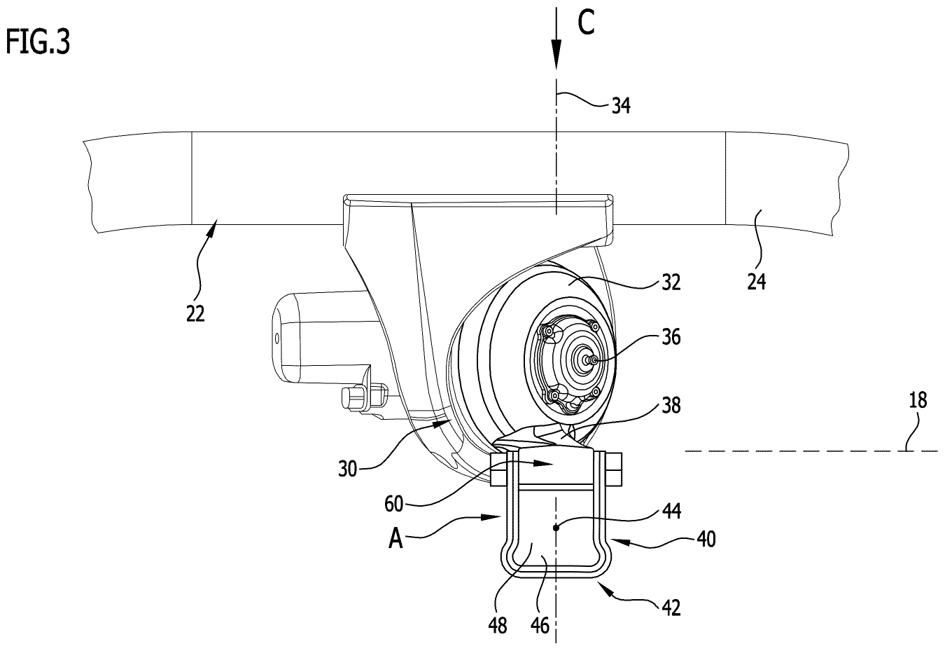

As illustrated in FIGS. 2 and 3, in a working position A the attachment element carrier 40 is arranged relative to the bumper unit 16 such that it lies below a lower edge 18 of the bumper unit 16, that is to say on a side thereof that faces a road surface 28, and thus the insertion receptacle 46 is freely accessible for insertion of the end region 58 of the coupling ball carrier 56, wherein the center axis 44 extends in the vehicle longitudinal center plane or the longitudinal center plane of the holding device 34.

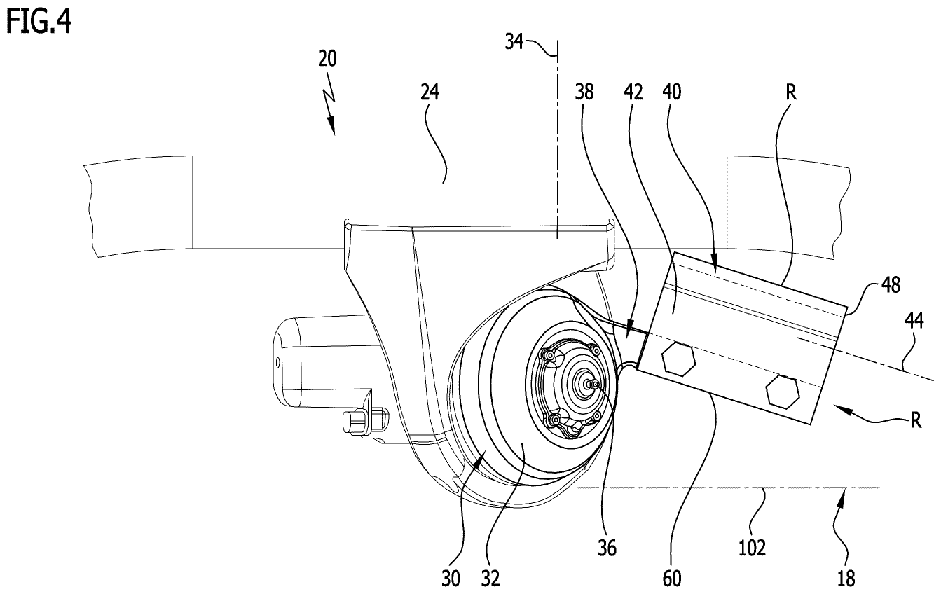

Because the pivot element 32 is mounted such that it is pivotal about the pivot axis 36 running obliquely to the longitudinal center plane 34, it is possible, as illustrated in FIGS. 3 and 4, to pivot the attachment element carrier 40 from the working position A, in which the receiving body 42 is below the lower edge 18 of the bumper unit 16, under the lower edge 18 and through into a rest position R illustrated in FIG. 4, in which the attachment element carrier 40 and thus in particular also the receiving body 42 lie above the lower edge 18 of the bumper unit 16 such that they are hidden by the bumper unit 16 and are thus arranged outside a visible region of the bumper unit 16 and the body 12, wherein the center axis 44 extends transversely to the vehicle longitudinal center plane 34 or the longitudinal center plane 34 of the holding device 20, and in so doing runs in particular such that it is inclined relative to the direction of the road surface 28.

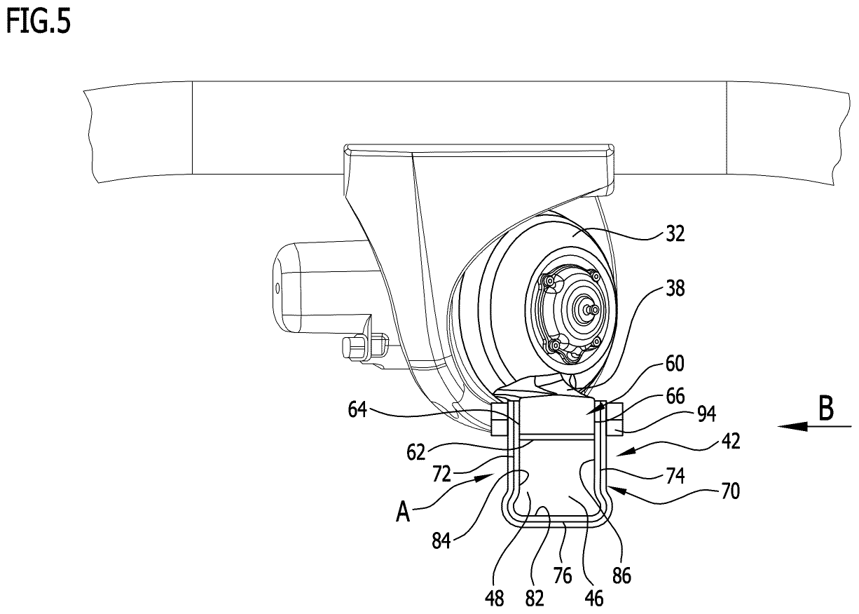

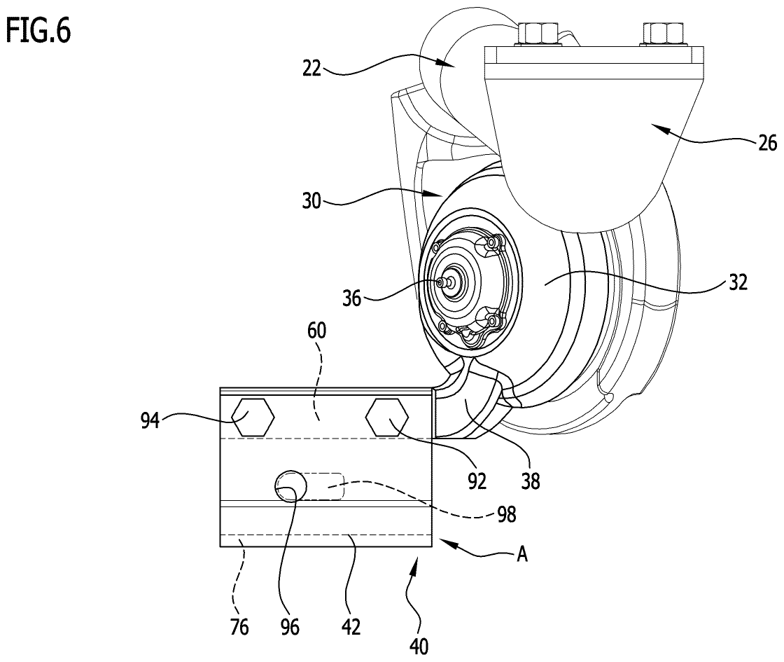

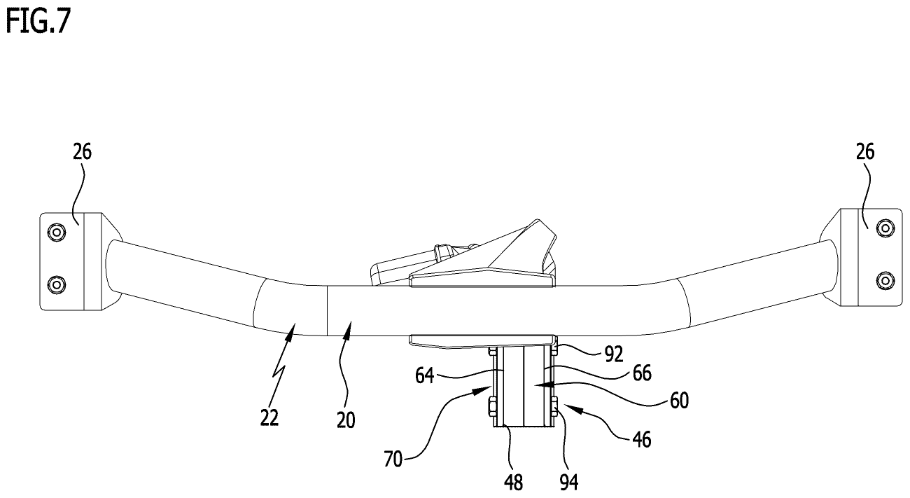

As illustrated in FIGS. 2 to 7, arranged on, and in particular integrally formed in one piece with, the connection arm 38 that extends from the pivot element 32 is a holding arm which is designated 60 as a whole and which, in the working position A (FIGS. 2, 3, 5 and 7), forms an upper transverse wall 62 of the insertion receptacle 46 and thus part of the receiving body 42.

For the purpose of forming the receiving body 42 as a whole, the holding arm 60 is supplemented by a supplementary body 70, which is U-shaped in cross section and has two side cheeks 72 and 74 and a base body 76 that is arranged opposite the holding arm 60, wherein the base body 76 forms the lower transverse wall 82 of the insertion receptacle 46, opposite the transverse wall 62, and the side cheeks 72 and 74 form the side walls 84 and 86 of the insertion receptacle 46.

The side cheeks 72 and 74 abut, laterally in relation to the holding arm 60, against its side faces 64 and 66 extending transversely to the transverse wall 62, and are connected to the holding arm 60 by screws 92 and 94 passing through it.

Thus, the holding arm 60 and the supplementary body 70 form the receiving body 42, which is firmly connected to the connection arm 38 by the holding arm 60, such that at one end the receiving body 42 is held in one piece on the connection arm 38 by the holding arm 60, and hence the supplementary body 70 achieves enough stability to impart the required stability to the receiving body 42 and also to connect it stably to the connection arm 38.

Preferably here, both the holding arm 60 and the supplementary body 70 extend over the entire length of the insertion receptacle 46 in the direction of its center axis 44, and are thus able to optimally take up forces acting on the receiving body 42 through the attachment element 50.

Moreover, in the region of the side cheeks 72, 74 the receiving body 42 is also provided with mutually opposite apertures 96 through which a securing bolt 98, which also reaches through the attachment element 50, is passable in order to fix the attachment element 50 in the receiving body 42.

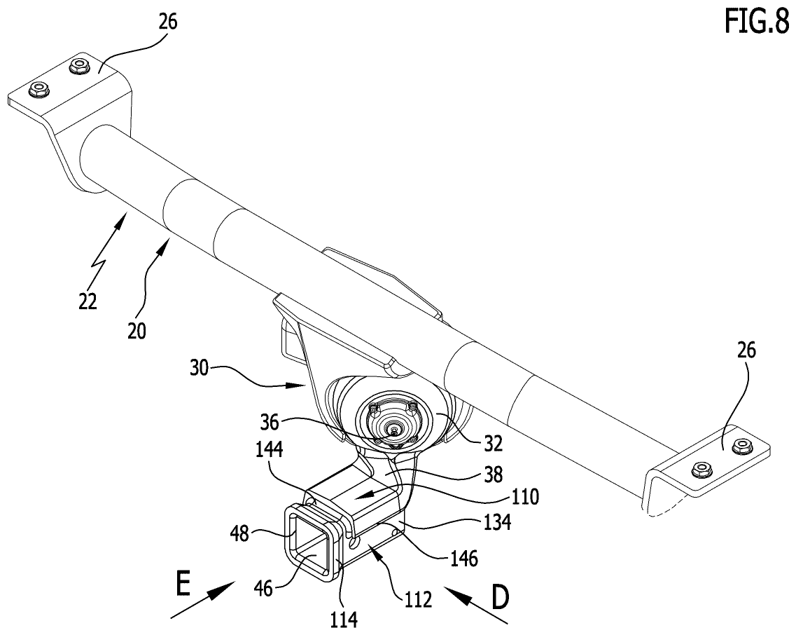

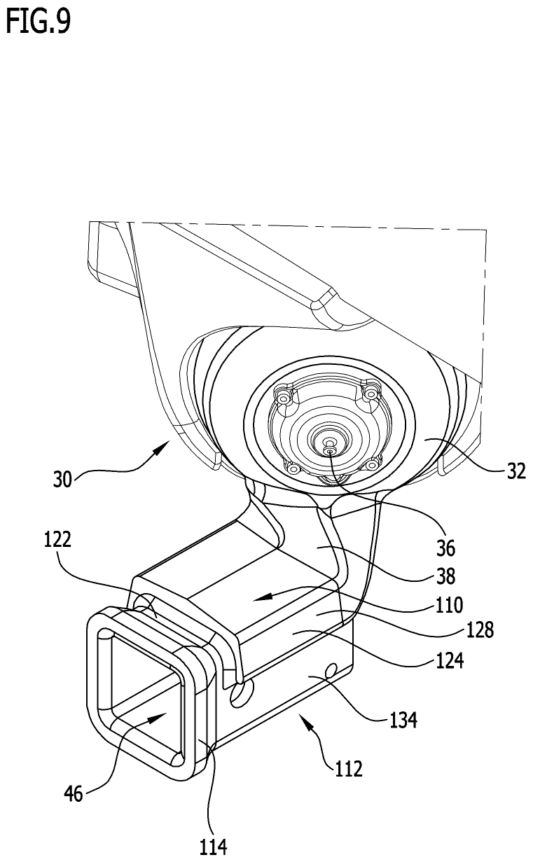

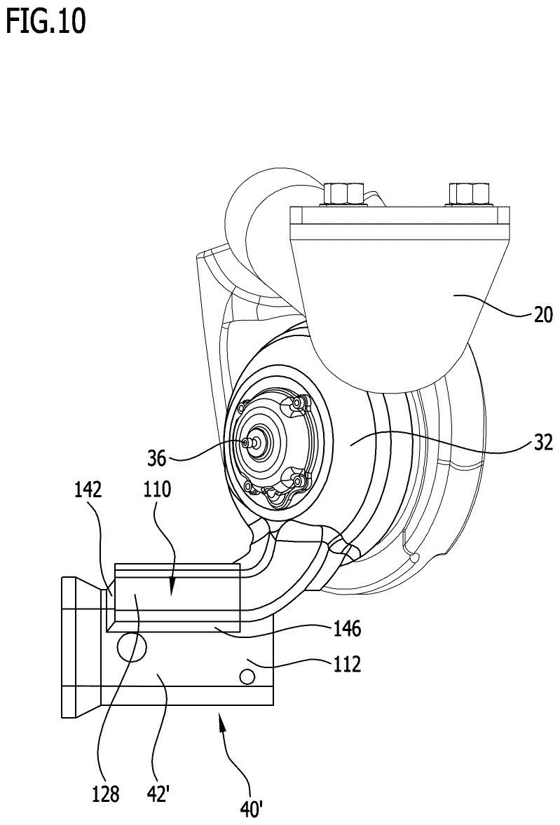

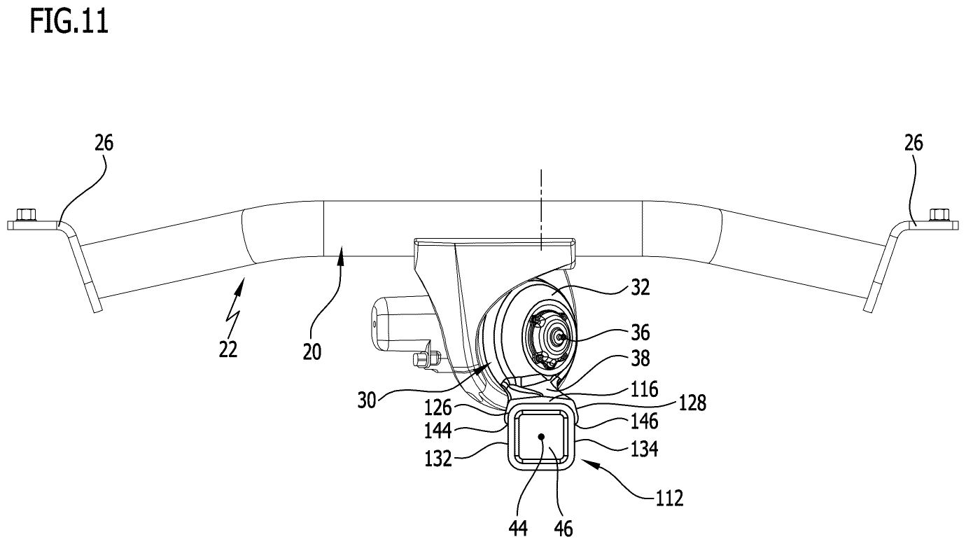

In a second exemplary embodiment, illustrated in FIGS. 8 to 11, the elements that are identical to those in the first exemplary embodiment are provided with the same reference numerals, with the result that with regard to these reference may be made to the description of the first exemplary embodiment.

In the second exemplary embodiment too, the connection arm 38 is provided with a second embodiment of a holding arm 110, which is in particular integrally formed in one piece with the connection arm 38.

Unlike the first exemplary embodiment, however, the receiving body 112 takes the form of a discrete, self-contained body which embraces and receives the insertion receptacle 46 and which, in the region of the rear insertion opening 48 of the insertion receptacle 46, surrounds it with a reinforcing annular body 114.

For the purpose of connection to the receiving body 112, the holding arm 110 bears against its longitudinal side, in particular an upper side 122, by a holding portion 124 that takes the form of an upside-down U and is also provided with lateral embracing elements 126, 128, which in a manner adjoining the upper side 122 of the receiving body 112 also abut against the upper region of longitudinal sides 132, 134 of the receiving body 112, and thus embraces the receiving body 112 in the upper region thereof with positive engagement.

For the purpose of fixing the holding portion 124 to the receiving body 112, it is connected at the outer edge regions thereof by weld seams 142, 144, 146.

1. A holding device that is mountable on a rear region of a body of a motor vehicle, comprising a pivotal bearing unit, which is mountable in a manner fixed to the vehicle on the rear region of the motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa, wherein by way of a connection arm the pivot element is provided with an attachment element carrier that has an insertion receptacle and in which the attachment element is insertable and fixable with positive engagement by an end region, wherein in the working position the insertion receptacle extends with its center axis substantially parallel to the longitudinal center plane, and wherein the attachment element carrier comprises a receiving body that has the insertion receptacle, wherein the connection arm is provided with a holding arm that is connected to the receiving body.

2. The holding device as claimed in claim 1, wherein the holding arm extends parallel to the center axis in the longitudinal direction of the receiving body.

3. The holding device as claimed in claim 2, wherein the holding arm forms a wall region of the receiving body that delimits the insertion receptacle.

4. The holding device as claimed in claim 2, wherein the holding arm forms an, in the working position, upper transverse wall of the receiving body.

5. The holding device as claimed in claim 3, wherein the receiving body comprises a supplementary body which is connected to the holding arm and forms the further side walls of the insertion receptacle.

6. The holding device as claimed in claim 3, wherein the supplementary body takes a form that is U-shaped in cross section.

7. The holding device as claimed in claim 3, wherein side cheeks of the supplementary body that adjoin the holding arm embrace the wall region formed by it on both sides.

8. The holding device as claimed in claim 7, wherein the side cheeks of the supplementary body are connected to side faces of the holding arm.

9. The holding device as claimed in claim 3, wherein the supplementary body is screwed to the holding arm.

10. The holding device as claimed in claim 1, wherein the holding arm abuts against a side of the receiving body.

11. The holding device as claimed in claim 10, wherein the holding arm abuts against at least one longitudinal side of the receiving body.

12. The holding device as claimed in claim 11, wherein the holding arm has a holding portion taking the form of an upside-down U and abutting against the receiving body.

13. The holding device as claimed in claim 12, wherein the holding portion is provided with lateral embracing elements which, laterally in relation to the longitudinal side of the receiving body that is covered by the holding portion, at least in certain regions abut against longitudinal sides that adjoin the longitudinal side.

14. The holding device as claimed in claim 12, wherein the holding portion is welded to the receiving body.
